(19) United States
(12) Patent Application Publication
(10) Pub. No.: US 2009/0026296 A1
(43) Pub. Date: Jan. 29, 2009

(54) TREE CHIPPER

(76) Inventors: Reggald Emory Isley, Grande Prairie (CA); David Hewings, Grande Prairie (CA)

Correspondence Address: OYEN, WIGGS, GREEN & MUTALA LLP;480 - THE STATION, 601 WEST CORDOVA STREET, VANCOUVER, BC, V6B 1G1, CA

(21) Appl. No.: 12/060,042

(22) Filed: Mar. 31, 2008

Related U.S. Application Data
(60) Provisional application No. 60/952,306, filed on Jul. 27, 2007.

(51) Int. Cl. B02C 18/06; B27L 11/00

(52) U.S. Cl. 241/91

(57) ABSTRACT

A tree chipper capable of reducing standing trees to chips has a rotating chipper, a feed mechanism for feeding trees into the chipper and a saw or the like for severing the trees. The tree chipper may comprise a boom that can be moved to position the tree chipper against a tree to be cut and chipped. In embodiments, the rotating chipper comprises a disc having chipping teeth on a face, a generally cylindrical chipper body having chipping teeth on an outer surface thereof and a conical chipper body.

### CROSS-REFERENCE TO RELATED APPLICATION

This application claims priority from U.S. application No. 60/952,306 filed 27 Jul. 2007. For purposes of the United States of America, this application claims the benefit under 35 U.S.C. §119 of U.S. application No. 60/952,306 filed 27 Jul. 2007 which is hereby incorporated herein by reference.

### TECHNICAL FIELD

This invention relates to apparatus and methods for chipping tress.

### BACKGROUND

In various circumstances it can be desirable to reduce trees to chips. For example, to preserve the health of a forest it can be desirable to kill and reduce to chips trees that are infested with parasites. There is a need for apparatus capable of cost-effectively reducing trees to chips.

### BRIEF DESCRIPTION OF DRAWINGS

Exemplary embodiments are illustrated in referenced figures of the drawings. It is intended that the embodiments and figures disclosed herein are to be considered illustrative rather than restrictive.

FIGS. 1A and 1B are highly schematic side and front views of a tree chipper according to an embodiment of the invention.

FIG. 2 is a flow chart illustrating a method according to an embodiment of the invention.

FIGS. 3A through 3E are respectively perspective, front, side, top and bottom views of a tree chipper according to a specific embodiment of the invention.

FIG. 4A is a perspective view of a saw blade of the tree chipper of FIGS. 3A to 3E. FIG. 4B is a detail of a chipper tooth portion of the saw blade of FIG. 4A.

FIG. 5 is a schematic elevation view of a tree chipper according to another embodiment of the invention.

FIGS. 6A through 6E are respectively perspective, front, side, and top views of a tree chipper according to another specific embodiment of the invention.

### DESCRIPTION

Throughout the following description specific details are set forth in order to provide a more thorough understanding to persons skilled in the art. However, well known elements may not have been shown or described in detail to avoid unnecessarily obscuring the disclosure. Accordingly, the description and drawings are to be regarded in an illustrative, rather than a restrictive, sense.

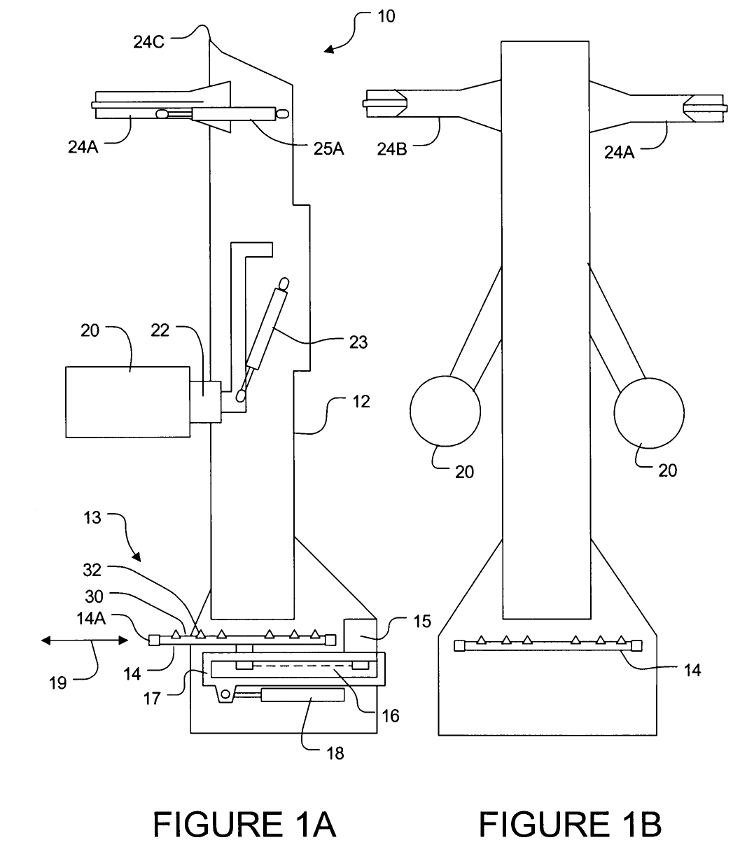

FIGS. 1A and 1B show very schematically a tree chipper 10 according to an embodiment of the invention. Tree chipper 10 may be mounted on the boom of an excavator or other boomed vehicle. Tree chipper 10 may be mounted in place of a digging bucket, for example. Tree chipper 10 may be mounted in the same manner as a tree processing head or feller bunching head could be mounted, for example. In some embodiments, tree chipper 10 is mounted to the boom by way of a swiveling coupler so that the orientation of tree chipper 10 can be adjusted to match that of a tree. In some such embodiments tree chipper 10 can be tilted toward or away from the vehicle and also tilted from side-to-side.

Tree chipper 10 includes a frame 12 which supports a cut-off saw indicated generally by 13. Cut-off saw 13 comprises a rotatable blade 14 driven by a suitable motor 15. Motor 15 may, for example, comprise a hydraulic motor, an electric motor, an internal combustion motor or the like. In some embodiments, a plurality of motors 15 drive the rotation of blade 14. In the illustrated embodiment, motor 15 drives blade 14 by way of a mechanical transmission 16 which may comprise suitable gears, belts and/or chains, for example. In alternative embodiments, motor 15 drives blade 14 directly.

Blade 14 is mounted to a sub-frame 17 which can be advanced or retracted by a suitable actuator 18. Actuator 18 may, for example, comprise a hydraulic or pneumatic piston, cable drive, other linear actuator, or the like. Arrow 19 illustrates the motion of sub-frame 17 and saw blade 14. Blade 14 has cutting teeth 14A around its periphery. Mounted on frame 12 above saw blade 14 are a pair of tree feeding rollers 20. Rollers 20 have spiked, textured, or other suitably-gripping outer faces to ensure good gripping contact between rollers 20 and a tree being processed.

Rollers 20 are driven by feed motors 22 and can be moved toward one another to grip a tree or away from one another to release a tree by an actuator 23. Also shown in the illustrated embodiment are grasping arms 24A and 24B which are respectively operated by actuators 25A and 25B. Grasping arms 24B can be advanced towards one another to grip a tree between themselves or opened to release the tree by actuators 25A and 25B. Grasping arms 24A and 24B may be sharpened on their upper edges so that they can perform a de-limbing function, as described below.

The upper face 30 of blade 14 (i.e. the face of blade 14 facing toward feed rollers 20) has chipping teeth 32 disposed on it. Chipping teeth 32 may be associated with apertures 33 in blade 14.

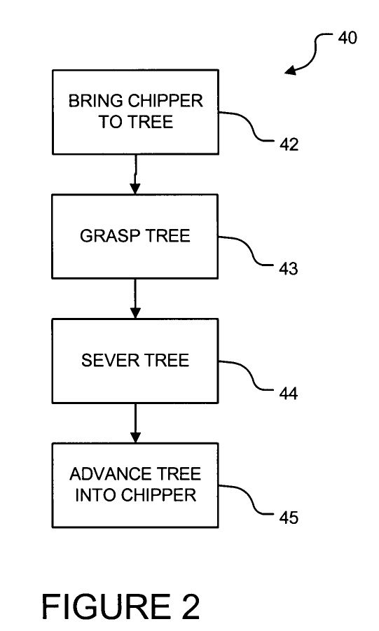

Apparatus 10 of FIGS. 1A and 1B can be operated according to a method 40 for chipping a tree as shown on FIG. 2. In block 42, apparatus 10 is brought to a standing tree that is to be chipped. This may be done, for example, by extending, swinging, or otherwise moving a boom on which apparatus 10 is supported, or by driving a vehicle carrying apparatus 10 to the standing tree which is to be chipped. In block 43, the tree is grasped. This may be done by grasping the tree between feed rollers 20, grasping the tree between arms 24A and 24B, or both. In block 44, the tree is severed by advancing rotating saw 14 through the tree by means of actuator 18. Teeth 14A on the periphery of blade 14 cut through the tree until the tree is severed.

In alternative embodiments, saw blade 14 is fixed relative to frame 12. In such embodiments, blade 14 may be advanced to sever a tree by urging apparatus 10 against the tree.

After the tree has been severed by blade 14, the tree remains held by feed rollers 20 and/or arms 24A and 24B. In block 45 chipping of the tree is initiated. While blade 14 remains in its extended position, feed rollers 20 are operated to advance the butt of the tree into chipping teeth 32 on face 30 of blade 14. The chipping teeth 32 reduce the tree to chips. The chips are ejected outwardly. In cases where blade 14 has apertures associated with chipping teeth 32, some or all of the chips may pass through the apertures.

As the tree is fed butt-first into chipping teeth 32, arms 24A and 24B may be closed around the trunk of the tree so that the sharp edges of arms 24A and 24B slice limbs off of the tree as the limbs are pulled past arms 24A and 24B. An additional limb knife 24C may be provided on frame 12 to sever any limbs that project over frame 12.

Shields or guides (not shown) may optionally be provided to deflect the chips which are produced when the butt of the tree interacts with chipping teeth 32 into a desired direction. Where apparatus 10 is equipped with arms 24A and 24B, the arms may remove limbs from the tree as the tree is fed downwardly onto blade 14 by feed rollers 20.

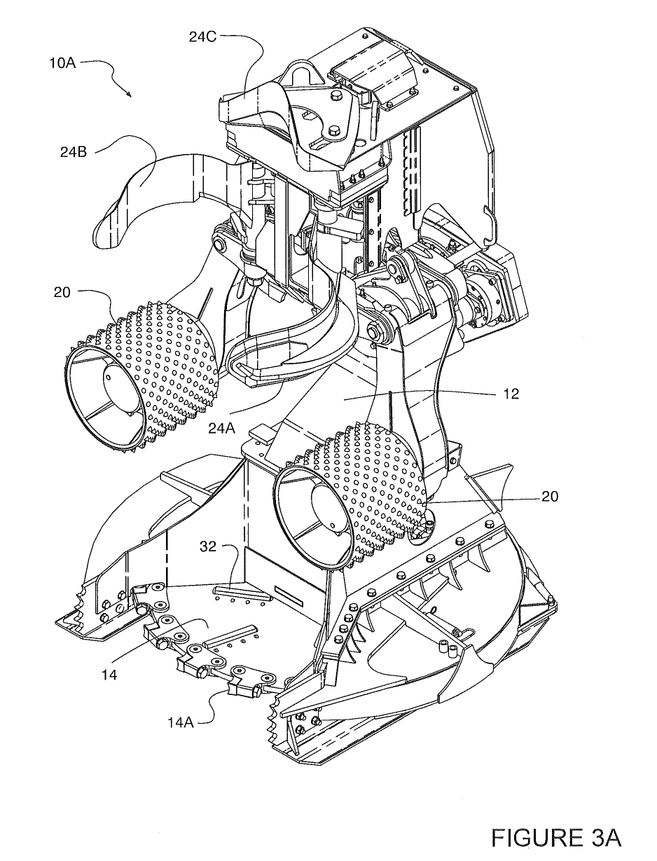

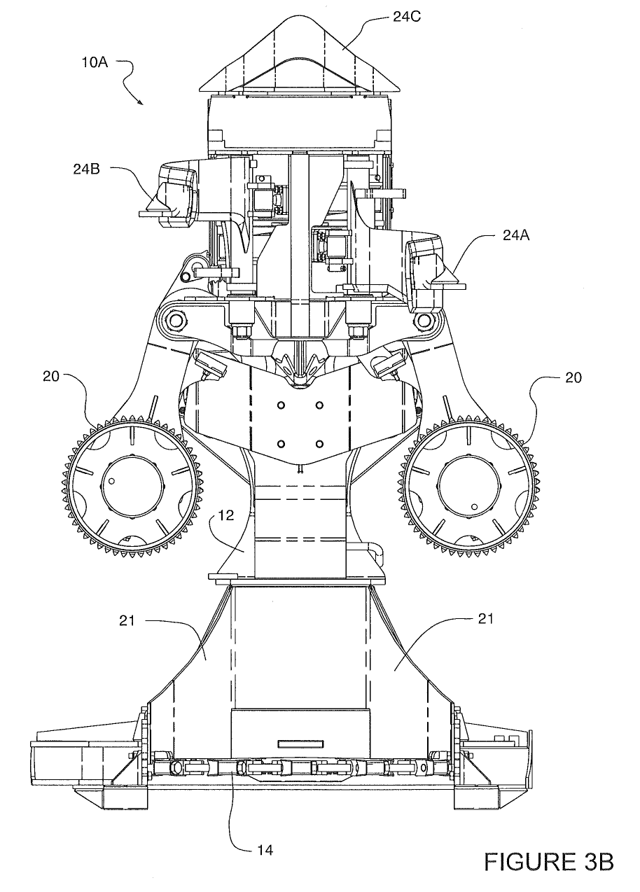

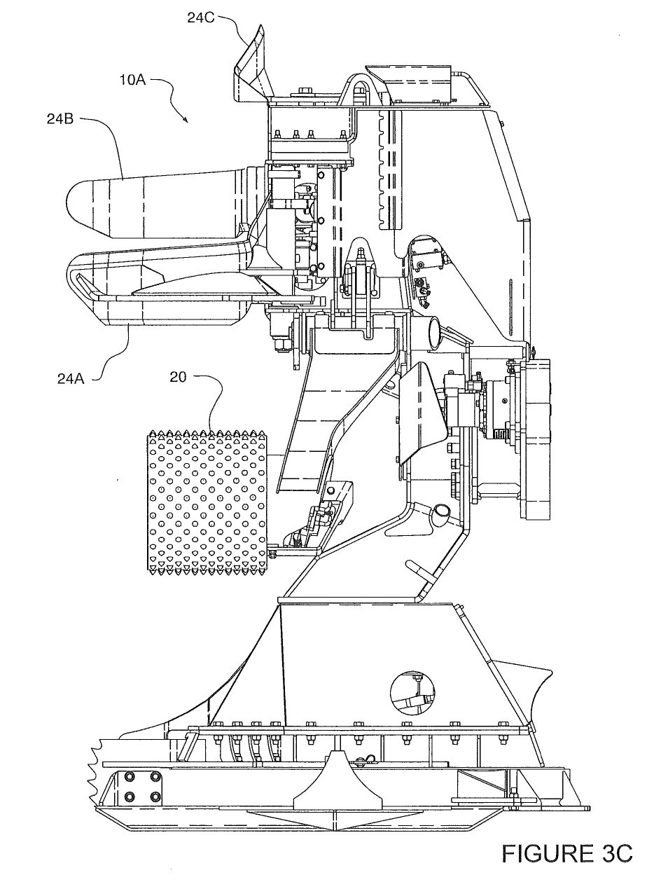

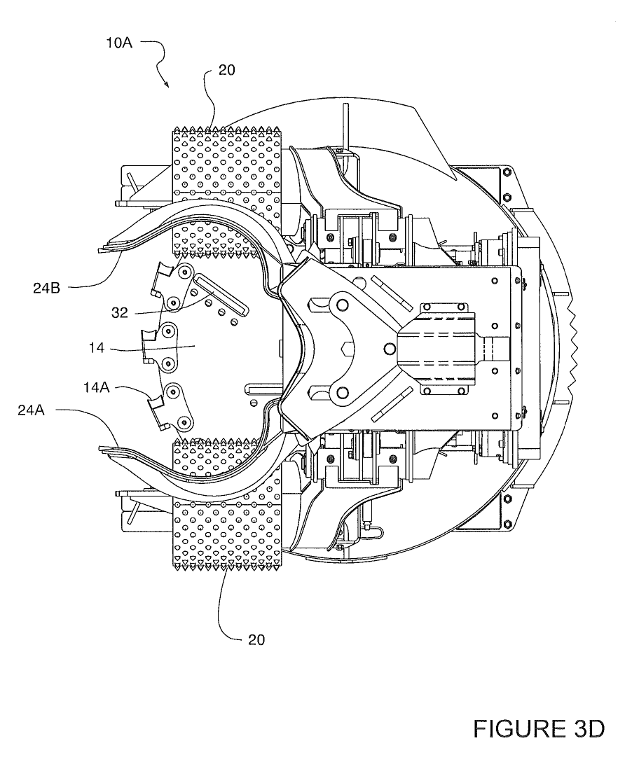

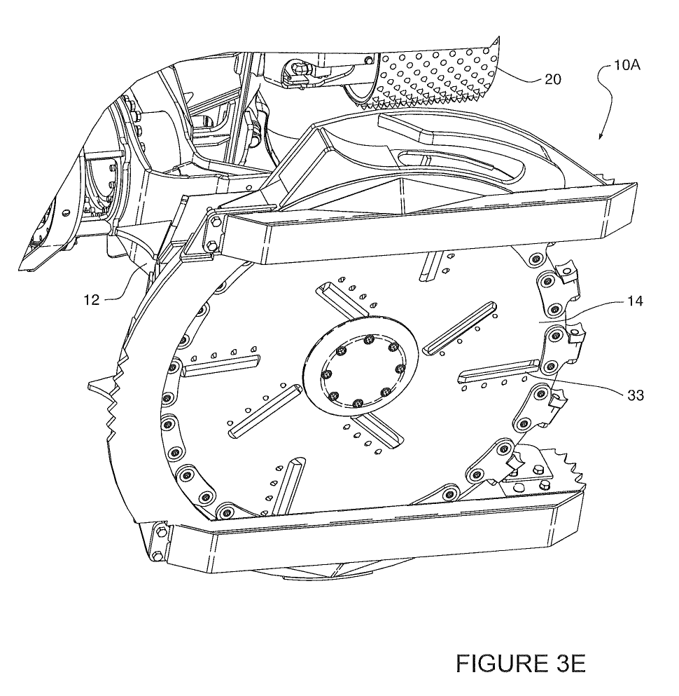

FIGS. 3A through 3E illustrate an apparatus 10A according to a specific example embodiment of the invention. In the illustrated embodiment, frame 12 comprises faces 21 which form a trough aligned generally with the feed path for a tree. Faces 21 can help to guide and steady the butt of the tree as it is fed into chipping teeth on the face of blade 14.

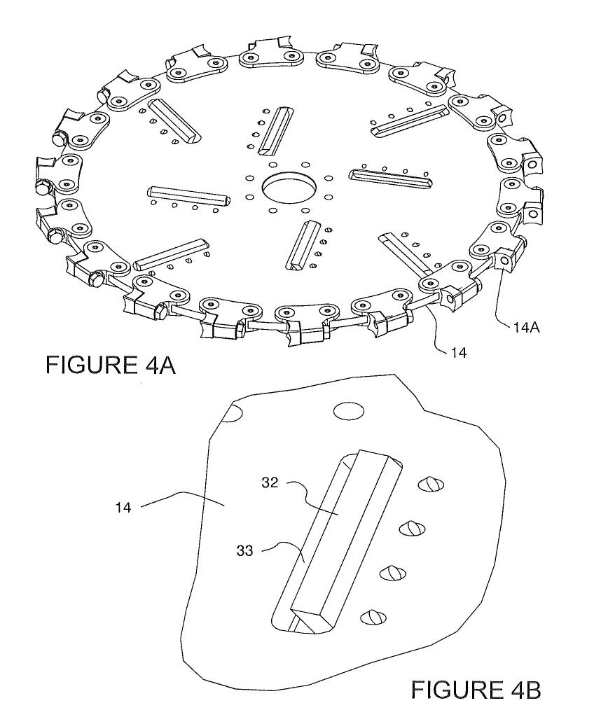

FIGS. 4A and 4B show a blade 14 of a type that may be used to practice the invention. Blade 14 comprises planer-type teeth 32 arranged in slots 33 on its face 40. Chips cut by teeth 32 are ejected through slots 33.

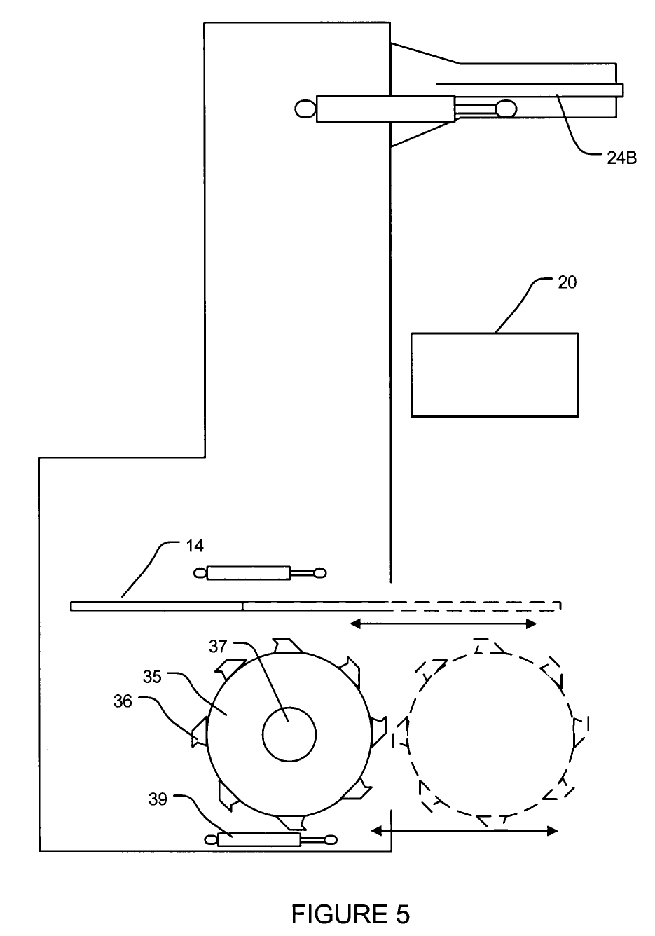

FIG. 5 shows an apparatus 50 according to an alternative embodiment of the invention in which the functions of severing and chipping the tree are separated. In apparatus 50, blade 14 lacks chipping teeth 32 on its face. A separate rotating chipping member is provided below feed rollers 20. In the illustrated embodiment, a rotatable drum 35 bearing chipping teeth 36 on its outer face and driven by a motor 37 is provided below blade 14. Drum 35 is mounted to a sub-frame which permits it to be advanced or retracted by an actuator 39.

Apparatus 50 of FIG. 5 may be operated substantially as described above with the exception that, after the tree has been severed by blade 14, blade 14 is retracted and drum 35 is advanced so that drum 35 is located below the butt of the tree (which is now held between feed rollers 20). Feed rollers 20 may then be operated to advance the tree downwardly onto the face of rotating drum 35. As drum 35 rotates, the chipping teeth 36 on the outer face of drum 35 reduce the tree to chips. In some embodiments, drum 35 rotates in a direction such that the side of drum 35 presented to the butt of the tree tends to urge the tree into greater contact with feed rollers 20.

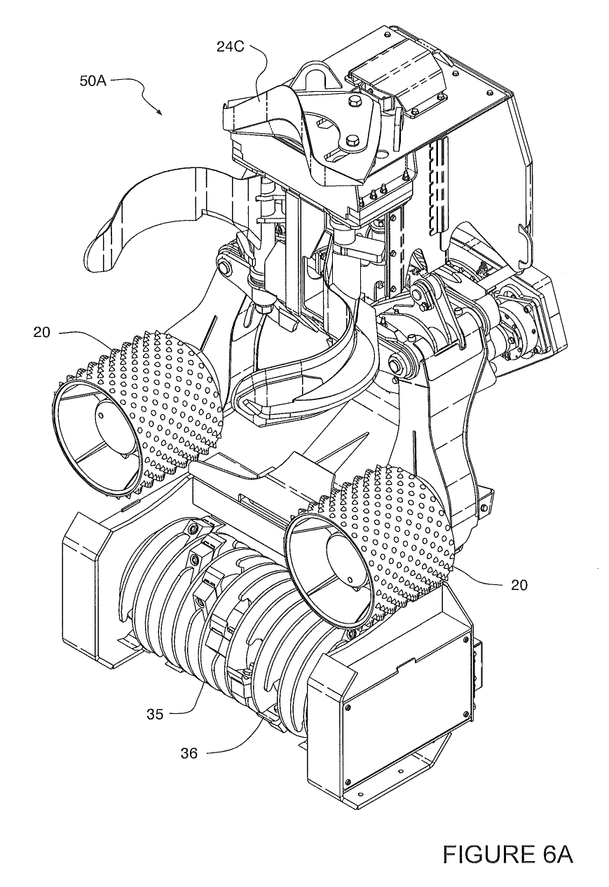

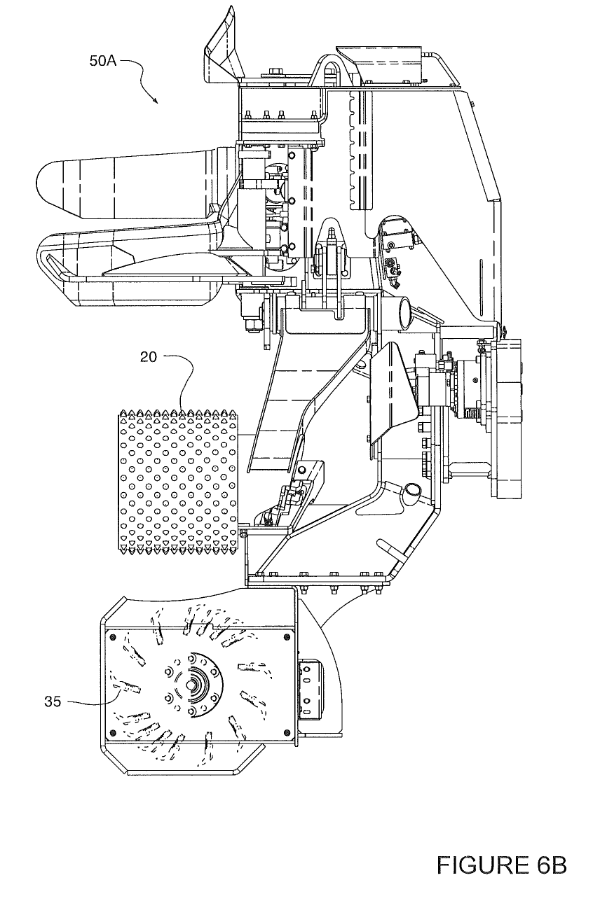

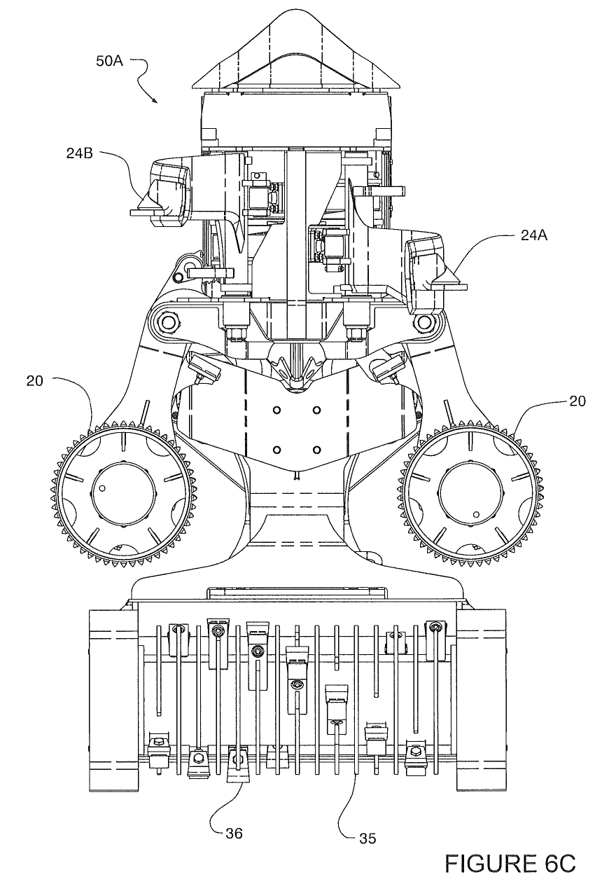

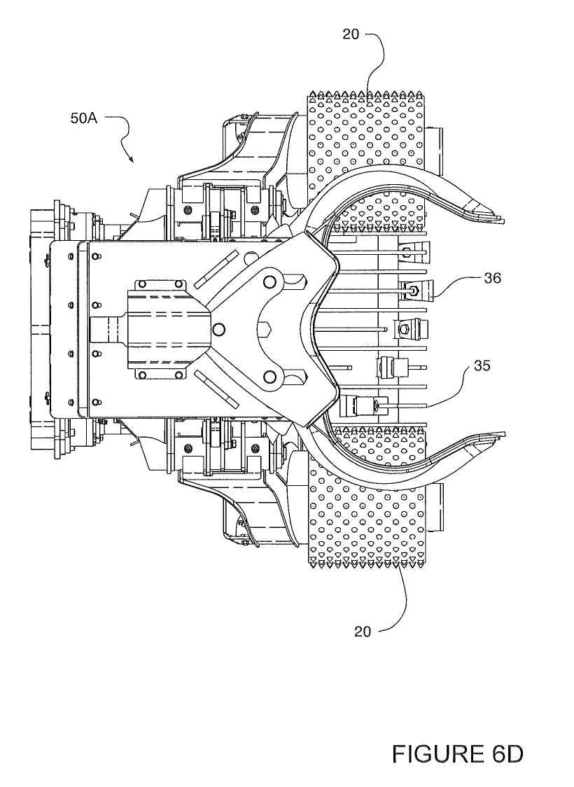

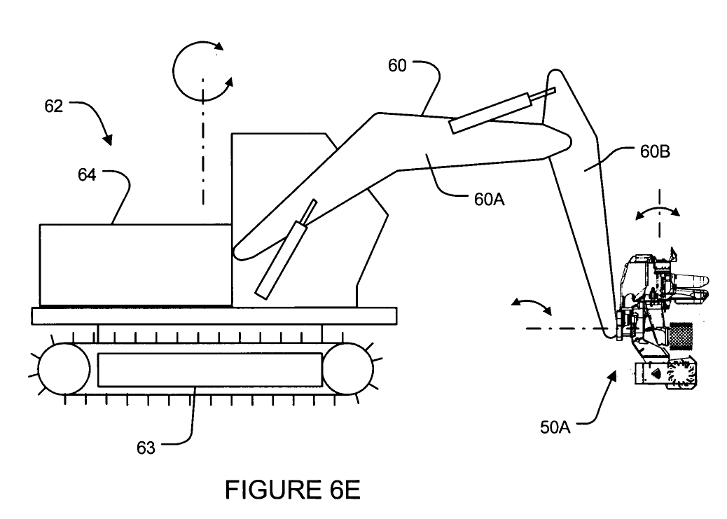

FIGS. 6A to 6D show apparatus 50A according to a further alternative embodiment of the invention that is similar to that shown in FIG. 5 except that the apparatus does not include a blade 14.

Apparatus 50A lacks a circular saw 14. Apparatus 50A can sever a tree by advancing rotating drum 35 into the tree while the drum is rotating. It is not mandatory that drum 35 be able to be advanced relative to frame 12. In embodiments where drum 35 is fixed, drum 35 may be located in line with the longitudinal axis along which feed rollers 20 will feed the tree. The position of drum 35 may be fixed relative to frame 12 and drum 35 may be advanced into a tree to sever the tree by moving frame 12 and drum 35 together against the tree.

Teeth 36 chip away the tree as drum 35 advances through the tree. After drum 35 has been advanced through the tree sufficiently to sever the tree then the butt end of the tree can be advanced onto drum 35 by rotating feed rollers 20 in order to chip the remainder of the tree.

As shown in FIG. 6E, apparatus 50A may be mounted at the end of a boom 60. Boom 60 is mounted to a vehicle 62 which comprises an undercarriage 63 pivotally mounted to a superstructure 64. By swinging superstructure 64 relative to undercarriage 63, boom 60 may be swung from side to side. Boom 60 may be extended or retracted by means of suitable actuators to bring apparatus into contact with a tree which is to be cut. Vehicle 62 does not necessarily have a tracked undercarriage as shown in FIG. 6E. Undercarriage 63 could comprise a wheeled, half-track or other undercarriage in the alternative. Apparatus according to other embodiments of the invention may be provided on boom 60 in place of apparatus 50A. Boom 60 comprises first and second segments 60A and 60B hinged together. Boom 60 could have other configurations than that shown. For example, boom 60 could optionally include a telescopically-extending section.

In a further alternative embodiment of the invention a chipper and a blade for severing the tree are provided by separate elements. In such embodiments, the blade for severing the tree may comprise any of:
a circular saw (like saw 14 described above);
a chain saw;
a tree shear; or
the like.
   In such embodiments, chipping may be performed by a rotating element having chipping teeth disposed on an upper face. The rotating element may comprise, for example, a disk, cone or the like. Where the rotating element comprises a disk, the disk may be inclined relative to the longitudinal axis along which the tree is fed or may be substantially perpendicular to the longitudinal axis.

It can be appreciated that at least some of the embodiments described herein permit effective chipping of trees that are standing on uneven ground. Further, with some embodiments it is possible to chip only the top portion of a tree while leaving a lower portion standing (or salvaging the lower portion for other uses).

In some embodiments, a controller associated with apparatus as described herein automatically controls the apparatus to reduce a tree to chips. In such embodiments, an operator may guide apparatus 10 into position adjacent to a tree to be chipped as described above and then trigger the controller to initiate an automatic sequence that will complete chipping the tree (e.g. by performing the steps of block 43 and the following blocks in FIG. 2). The controller may, for example, comprise a data processor executing software instructions that is connected to control the actuators of an apparatus 10, 50 or 50A by way of suitable interfaces.

Certain implementations of the invention comprise computer processors which execute software instructions which cause the processors to perform a method of the invention. For example, one or more processors in a controller for a tree chipper may implement methods as described herein by executing software instructions in a program memory accessible to the processors. The invention may also be provided in the form of a program product. The program product may comprise any medium which carries a set of computer-readable instructions which, when executed by a data processor, cause the data processor to execute a method of the invention. Program products according to the invention may be in any of a wide variety of forms. The program product may comprise, for example, media such as magnetic data storage media including floppy diskettes, hard disk drives, optical data storage media including CD ROMs, DVDs, electronic data storage media including ROMs, PROMs, flash RAM, or the like. The computer-readable instructions on the program product may optionally be compressed or encrypted.

Where a component (e.g. a software module, processor, assembly, device, circuit, etc.) is referred to above, unless otherwise indicated, reference to that component (including a reference to a “means”) should be interpreted as including as equivalents of that component any component which performs the function of the described component (i.e., that is functionally equivalent), including components which are not structurally equivalent to the disclosed structure which performs the function in the illustrated exemplary embodiments of the invention.

While a number of exemplary aspects and embodiments have been discussed above, those of skill in the art will recognize certain modifications, permutations, additions and sub-combinations thereof. For example:
while the embodiments above provide feed rollers 20 for feeding trees into a chipper that act directly on a tree being fed, in other embodiments, a feed mechanism may comprise belts having suitably textured faces to grip a tree and feed the tree into a rotating chipper member or another suitable tree-feeding mechanism. In such embodiments the feed rollers may drive motion of the belt.
   It is therefore intended that the following appended claims and claims hereafter introduced are interpreted to include all such modifications, permutations, additions and sub-combinations as are within their true spirit and scope.

What is claimed is:

1. A chipper comprising:
a circular saw having a peripheral edge and a face, the circular saw having cutting teeth around the peripheral edge and chipping teeth disposed on the face;
a feed mechanism spaced apart from the face;
a motor connected to operate the feed mechanism to feed a tree against the face while the circular saw is turning.

2. A chipper according to claim 1 wherein the feed mechanism comprises a plurality of feed rollers and the chipper comprises one or more actuators connected to urge the feed rollers against a trunk of a tree to be chipped.

3. A chipper according to claim 2 wherein the circular saw is mounted to a carriage and the carriage is mounted so that it can be advanced and retracted along a path extending substantially at right angles to an axis of rotation of the circular saw.

4. A chipper according to claim 3 wherein the circular saw comprises a disc having apertures passing through from the fact to an opposed face and the chipping teeth are arranged adjacent to the apertures.

5. A chipper according to claim 4 wherein the chipper teeth comprise elongated knives arranged along edges of the apertures.

6. A chipper according to claim 5 wherein the apertures comprise elongated slots.

7. A chipper according to claim 6 comprising a pair of delimbing arms located on a side of the feed roller away from the circular saw wherein a straight path for accepting a trunk of a tree to be chipped extends between the delimbing arms and past the feed roller to the circular saw.

8. A chipper according to claim 1 wherein the circular saw and feed roller are mounted to a frame and the frame is coupled at an end of a boom.

9. A chipper according to claim 8 wherein the boom is mounted to a vehicle and the boom is retractable, extendable and can be swung relative to an undercarriage of the vehicle.

10. A chipper according to claim 9 wherein the boom comprises a first segment pivotally coupled to the vehicle and a second segment pivotally coupled to the first segment wherein the frame is pivotally coupled to the second segment at an end thereof.

11. A chipper comprising:
a frame defining a feed path for a tree, the frame supporting:
a saw for severing a tree, the saw extendable into the feed path to sever a tree and retractable out of the feed path;
a feed mechanism comprising a feed roller spaced apart from the saw to feed a tree along the feed path; and,
a rotary chipping member carrying chipping teeth extendable into the feed path on a side of the saw away from the feed roller and retractable out of the feed path.

12. A chipper according to claim 11 wherein the saw comprises a circular saw having a peripheral edge and a face, the circular saw has cutting teeth around the peripheral edge and the circular saw is mounted to a carriage and the carriage is mounted to the frame so that the carriage can be advanced and retracted along a path extending substantially at right angles to an axis of rotation of the circular saw.

13. A chipper according to claim 11 wherein the saw comprises a chain saw.

14. A chipper according to claim 11 wherein the chipping member comprises a drum rotatable about an axis substantially at right angles to the feed path and the chipping teeth are on a generally cylindrical outer face of the chipping member.

15. A chipper according to claim 11 wherein the chipping member comprises a disk rotatable about an axis and the chipping teeth are on a face of the disc.

16. A chipper according to claim 15 wherein the axis of rotation of the chipper member is substantially parallel to the feed path.

17. A chipper according to claim 15 wherein the axis of rotation of the chipper member is at an acute angle to the feed path.

18. A chipper according to claim 11 wherein the chipping member comprises a member having a conical face that is rotatable about an axis of symmetry of the conical face and the chipping teeth are on the conical face.

19. A chipper according to claim 11 comprising a pair of delimbing arms located on a side of the feed roller away from the circular saw wherein a straight path for accepting a trunk of a tree to be chipped extends between the delimbing arms and past the feed roller to the circular saw.

20. A chipper according to claim 11 wherein the circular saw and feed roller are mounted to a frame and the frame is coupled at an end of a boom.

21. A chipper according to claim 20 wherein the boom is mounted to a vehicle and the boom is retractable, extendable and can be swung relative to an undercarriage of the vehicle.

22. A chipper comprising:
an undercarriage;
a superstructure mounted to the undercarriage for rotation about a generally upright swing axis;
a boom having a proximal end mounted to the superstructure, the boom being extendable and retractable relative to the superstructure;
a chipping head mounted at a distal end of the boom, the chipping head comprising:
a frame;
a feed mechanism mounted to the frame;
a rotary chipping member mounted to the frame at a location spaced apart from the feed roller along a feed path; and
a motor connected to rotate the feed roller to feed a tree against the rotary chipping member while the rotary chipping member is turning.

23. A chipper according to claim 22 wherein the rotary chipping member comprises a cylindrical member having chipping teeth on an outer cylindrical face thereof.

24. A chipper according to claim 22 wherein the rotary chipping member comprises a rotatable disc having chipping teeth on a face thereof and cutting teeth around a peripheral edge thereof.

25. A chipper according to claim 22 comprising a tree severing saw mounted to the frame.

26. A chipper according to claim 25 wherein the tree severing saw comprises cutting teeth disposed around a periphery of the chipping member.

27. A chipper according to claim 25 wherein the tree severing saw is extendable into the feed path to sever a tree and retractable out of the feed path.

28. A method for chipping a tree, the method comprising:
bringing a tree chipper adjacent to the tree;
in either order, severing the tree by urging a rotating circular saw carried on the tree chipper against the tree and grasping the tree at least in part by urging at least one feed roller against a trunk of the tree; and, driving the tree against chipper teeth on a face of the rotating circular saw to reduce the tree to chips at least in part by rotating the feed roller.
